(19) United States
(12) Patent Application Publication
(10) Pub. No.: US 2023/0419228 A1
(43) Pub. Date: Dec. 28, 2023

(54) MACHINE LEARNING BASED MULTIYEAR PROJECTION PLANNING FOR ENERGY SYSTEMS

(71) Applicant: Xendee Corporation, San Diego, CA (US)

(72) Inventors: Michael Stadler, Encinitas, CA (US); Zachary K. Pecenak, San Diego, CA (US)

(21) Appl. No.: 18/215,735

(22) Filed: Jun. 28, 2023

Related U.S. Application Data
(60) Provisional application No. 63/356,323, filed on Jun. 28, 2022.

(51) Int. Cl. G06Q 10/0637; G06Q 50/06

(52) U.S. Cl. CPC G06Q 10/06375; G06Q 50/06

(57) ABSTRACT

A machine learning based multiyear projection planning for energy systems is disclosed. In some embodiments, a method comprises: obtaining input data for an energy system; determining one or more projection factors based on the input data; determining, based on a machine learning model, an operation or investment associated with the energy system to achieve lower cost or improve one or more metrics of the energy system for the multiyear horizon based at least in part on the one or more projection factors and a description of technology or infrastructure of the energy system; generating a recommended operation or investment decision for the energy system based at least in part on output of the machine learning model; and storing the recommended operation or investment decision.

### RELATED APPLICATION

This application claims the benefit of priority from U.S. Provisional Application No. 63/356,323, for “Machine Learning Based Multiyear Projection Planning for Energy Systems,” filed Jun. 28, 2022, which provisional patent application is incorporated by reference herein in its entirety.

### TECHNICAL FIELD

The subject matter of this application relates generally to cloud computing and computer information systems applications for energy generation and usage planning using machine learning models.

### BACKGROUND

Currently, there are no Microgrid and Distributed Energy Resources (DER) project planning methods that consider, among other forecasts: 1) grid conditions; 2) technology, fuel, and electricity pricing; 3) regulatory constraints; or 4) climate conditions, for multiple years into the future using a time effective simulation or optimization approach in the planning decision making.

Microgrid and DER project planning is typically performed by modeling, simulating, or optimizing energy and power provisions in a computer or cloud-based environment that considers among others: 1) grid conditions; 2) technology, fuel, and electricity pricing; and 3) regulatory changes, where the objective is to minimize cost and emissions while maximizing resilience and reliability of the system under the physical constraints of the system. The constraints are applied at discrete intervals, which typically represent a time series (e.g., 8760 timesteps representing a year at hourly intervals).

Shorter time intervals, or longer horizons lead to increases in solution time since the number of calculations are increased. Shorter time intervals provide the benefit of capturing dynamic behavior caused by climate transients or random failures. Longer time horizons provide the benefit of incorporating price or regulatory changes. The existing method of extending the time horizon is referred to hereafter, as the “forward-looking” approach. To save runtime, planning tools typically are only applied for a year where future conditions are either ignored or averaged into the current data. Hereafter, the status quo, of only solving a single year and assuming constant conditions over the project lifetime is referred to as the SYO (Single Year Optimization).

The effect is that all input data is considered frozen for the entire project lifetime, which is unrealistic. However, microgrid and DER project planning decisions produce recommendations of investment, operation, and placement that apply to equipment and infrastructure with lifespans up to 50 years which can be significant in terms of capital investment or financial agreements.

The energy, Microgrid and DER recommendations will not be valid as the energy landscape changes and could result in significant economic loss for stakeholders in the project and environmental impacts on society at large. Further, projections of Net Present Value (NPV) and Internal Rate of Return (IRR), which are critical indicators of project viability can be significantly skewed, lowering the likelihood and confidence of investment in Microgrid and DER projects.

When multiple years are considered, the planning is performed by modeling, simulating, or optimizing considering the entire horizon of years simultaneously, by expanding the number of timesteps, i.e., the forward-looking approach. This forward-looking approach necessitates solving the entire time horizon simultaneously, assuming perfect knowledge about each timestep. However, when applying this approach, the time required to model, simulate, or optimize increases non-linearly with the number of years, typically in a non-predictable manner. Depending on the time horizon, time increases can be as large as 10,000%. Further such methods strictly rely on the data forecasts, which are inherently uncertain. This leads to results that are very sensitive to forecast errors.

A stochastic element can be added to the data to hedge against the uncertainty, but that further adds to the number of decisions to be made, increasing runtime further. For this purpose, a stochastic approach is one which considers multiple future scenarios simultaneously, typically through expansion of the decision variables.

Simplifications to the Microgrid and DER system that is being modeled, simulated, or optimized is typically employed to combat the time increase. However, such simplifications distort the reality that the economic planning is emulating to provide recommendations for. This approach is the current art and is called the TMYO (Typical Multiyear Optimization) hereafter. Other methods simply ignore future information, making consecutive decisions on current data (updating with time) which accumulate. However, these methods are prone to oversizing when future conditions are less than today.

In sum, there is no existing methods that can plan over multiple years, and which provide acceptable results considering uncertain future scenarios and predictable increase in runtime.

### SUMMARY

The embodiments disclosed herein are directed to a fast multiyear projection Microgrid and DER planning method that uses optimization, simulation, or modeling, and takes in account cost calculations, emission calculations, technology investments and operation in a computer or cloud-based environment. In an embodiment, the computing platform is deployed on a network (cloud computing platform) that can be accessed by a variety of stakeholders (e.g., investors, technology vendors, energy providers, regulatory authorities). In an embodiment, the planning platform implements at least one of artificial intelligence (AI), machine learning (e.g., neural networks, such a convolutional neural networks or feed-forward neural networks), forecasting, or historical data to estimate various planning parameters for one to an infinite number of years.

The disclosed embodiments do not change the underlying problem formulation model. Instead, one or more projection factors are applied to input data to represent expected conditions for that input in the future. The one or more projection factors represent condensed versions of forecasts of model inputs over the project horizons. For example, a projection factor of 2 applied to the load at each timestep (t) indicates that the model will optimize (and thus plan) around two times the load in the optimization (Lₜ_{_{projection}}=Lₜ*2). Simultaneously applying projection factors to each input in the model of interest allows the model to optimize investments (and operation and placement) for a projected ‘future scenario’. The projected data can be applied to any model input, regardless of approach (e.g., simulation, optimization, machine learning, etc.).

Forecasts of input data changes are typically given in one of three ways: (i) as varying single value increase factors (e.g., 5%) for each year of a project horizon (e.g., 20 years) for each input; (ii) a timeseries of values given for each timestep of each year within the project horizon for each input; or (iii) a combination of the first two approaches. In the forward-looking approach, these forecasts are solved directly in the planning model.

When the planning problem is solved applying the projected data, a solution is obtained which no longer represents the original data, but rather a “future scenario” created by the projected data. As such, optimal asset selection, sizing, placement, and dispatch are created for this scenario. This can be thought of as a type of “average” future scenario, as opposed to any real year within the horizon.

To get accurate operational results for each year, or to provide incremental sizing at multiple points in the planning horizon, the disclosed embodiments are combined with an adaptive multiyear approach. The adaptive multiyear approaches solve a single year solution repeatedly, making investment decisions at the beginning of the horizon (e.g., before the first year). In the adaptive multiyear approach, each solution represents a different starting year and is dependent on the prior solution (years). Hereinafter, this approach is referred to as Multiyear Projection Optimization (MPO).

The input parameters such as electricity, heating, cooling, or other demand, prices, and regulatory constraints for each optimization in the MPO are updated to match the forecasted value for the given year or horizon, multiplied with the projection factor if a sizing is being computed in a given year. Investment decisions made in previous years are considered fixed and carried into the current solution, where new investments can be made. When a technology asset reaches its useful lifetime, the asset is discarded and the solver (e.g., linear programing (LP) optimization solver or simulation) is able to invest freely to fill the void (or not invest at all if it makes economic or environmental sense).

The disclosed embodiments retain the positives of the adaptive multiyear method (e.g., uses a shorter time horizon, applying current data to make investment decisions, and ignoring the full profile). However, it improves the adaptive multiyear approach by preparing for a changing future, which might require significant investment for load growth, or avoid over-investments in the case of load decreases.

In terms of runtime, the method solves a subset of timesteps simultaneously, Y times, indicating a linear time increase (e.g., for a 20-year solution at hourly interval you are solving 8760 timesteps simultaneously 20 times). In contrast, if the forward-looking approach is used, the solver must solve all timesteps simultaneously (e.g., for a 20-year solution at an hourly interval there is 175,200 simultaneous timesteps). Less simultaneous timesteps is computationally desirable, since solution run-times grow non-linearly with the number of timesteps, due to an increase in the number of possible solutions.

The input to the model is a system state representing: (1) the current technology assets on-site or in the energy system; (2) the system constraints such as energy prices, regulations, and climate conditions; and (3) a forecast of model inputs over a specified horizon (for example, 5 or 15 years). The forecasts can be provided by any technique such as AI (including machine learning), stochastic or deterministic approaches, or can be user generated. The forecasted or user specified data can be for any time horizon less than the project horizon.

In some embodiments, a method comprises: obtaining, with at least one processor, input data for an energy system; determining, with the at least one processor, one or more projection factors based on the input data, the one or more projection factors to condense forecasts for the energy system, over a multiyear horizon, into a single number to represent future conditions associated with the energy system, where the one or more projection factors tune the impact of the future forecasts using a discount rate; determining, with the at least one processor and based on a machine learning model, an operation or investment associated with the energy system to achieve lower cost or improve one or more metrics of the energy system for the multiyear horizon based at least in part on the one or more projection factors and a description of technology or infrastructure of the energy system; generating, with the at least one processor, a recommended operation or investment decision for the energy system based at least in part on output of the machine learning model; and storing, with the at least one processor, the recommended operation or investment decision.

In some embodiments, the input data is a state of the energy system representing technology assets on-site or in the energy system, system constraints, and a forecast of inputs over the multiyear horizon.

In some embodiments, the forecast of inputs is generated using machine learning.

In some embodiments, the one or more projection factors are determined for and applied to each timestep of the multiyear forecasts for input data which is time dependent.

In some embodiments, a single projection factor is determined for and applied across all time-steps of the multiyear forecasts.

In some embodiments, new investments resulting from a first iteration of the method are added to the input data in a following iteration of the method.

In some embodiments, the method further comprises: determining, using an adaptive multiyear approach, accurate dispatch for each year of the multiyear horizon based on the investment, or an incremental dispatch by combining the adaptive multiyear approach with the machine learning model and the one or more projection factors.

In some embodiments, a method comprises: in an iterative process: obtaining, with at least one processor, input data associated with an energy system; obtaining, with the at least one processor, a specified year for investing in the energy system; determining, with the at least one processor, one or more projection factors for future forecasts over a multiyear horizon based on the input data; solving, with the at least one processor, a first optimization problem on the investment in the energy system, over the multiyear horizon, based at least in part on the one or more projection factors and a description of the technology or infrastructure of the energy system; solving, with the at least one processor, a second optimization problem on operation of the energy system for the specified year based on a solution of the first optimization problem; and recording, with the at least one processor, forecast data resulting from solutions of the first and second optimization problems on a storage device.

In some embodiments, the one or more projection factors tune the impact of the future investment forecasts using a discount rate.

In some embodiments, the second optimization problem is solved using an adaptive year approach that determines a dispatch for each year of the multiyear horizon considering the investment, or an incremental dispatch.

In some embodiments, the input data is state of the energy system representing technology assets on-site or in the energy system, system constraints, and a forecast of inputs over the multiyear horizon.

In some embodiments, the forecast of inputs is generated using machine learning.

In some embodiments, the one or more projection factors are determined for and applied to each timestep of solving the first optimization problem for input data which is time dependent.

In some embodiments, a single projection factor is applied across all time-steps of the solving of the first optimization problem.

In some embodiments, a first solution to the first optimization problem represents a current condition of the energy system, restricts any new investment, and determines operating conditions of the energy system in its present state, and a second solution to the second optimization problem uses the determined operating conditions as additional input into the second solution, and removes the restriction on investment to purchase generation resources to improve the operating conditions of the energy system.

In some embodiments, new investments resulting from a first iteration of the method are added to the input data in a following iteration of the method.

In some embodiments, a system comprises: at least one processor; memory storing instructions that when executed by the at least one processor, cause the at least one processor to perform operations comprising: obtaining input data associated with an energy system; obtaining a specified year for investing in the energy system; determining one or more projection factors for future investment forecasts over a multiyear horizon based on the input data; solving a first optimization problem on the investment in the energy system, over the multiyear horizon, based at least in part on the one or more projection factors and a description of the technology or infrastructure of the energy system; solving a second optimization problem on operation of the energy system for the specified year based on a solution to the first optimization problem; and recording forecast data resulting from solutions of the first and second optimization problems on a storage device.

### DESCRIPTION OF DRAWINGS

FIG. 1 are example graphs illustrating the embodiment disclosed herein (third plot, labeled MPO) which is using projection factors (described below) in the 1^{st} and 15^{th} year to get sizing. The 1^{st} year calculates projection factors based on the first 20 years of data, while the 15^{th} year uses years 15 through 30. Dispatch solutions are presented for al thirty years to get accurate economics. The prior art methods such as forward looking (TMYO in the graph), and the single year optimization (SYO in the graph) are also visualized here.

FIG. 2. is a block diagram explaining the MPO procedure, according to one or more embodiments.

FIG. 3 is an example of calculating the projection factor based on the discounting approach, with different discount rates (δ) considered and the corresponding projection factor. The method of calculating the projection factors via a MAX operator is also shown, as it is useful for islanded microgrids which favor energy sufficiency over economics.

FIG. 4 compares the Net Present Value (NPV) of the solutions from the single year optimization (SYO), the multiyear projection optimization (MPO), and the forward-looking optimization (TMYO) approaches. It is clear that the MPO produces solutions close to TMYO but in much less time, while both MPO and TMYO do much better than SYO. The NPV is shown as a function of time to show how the solutions converge. As shown, MPO produces solutions very close to TMYO, while improving significantly over SYO. Importantly, the plot shows SYO over investing and losing money over the project, while MPO swiftly avoids that due to its information about the future.

FIG. 5 describes a high-level example problem formulation for energy, microgrid, or DER projects where there is an objective that is subject to realistic operating constraints, according to one or more embodiments.

FIG. 6 is a flow diagram of an MPO process, according to one or more embodiments.

FIG. 7 is a computer architecture suitable for running the MPO process described in reference to FIG. 6.

### DETAILED DESCRIPTION

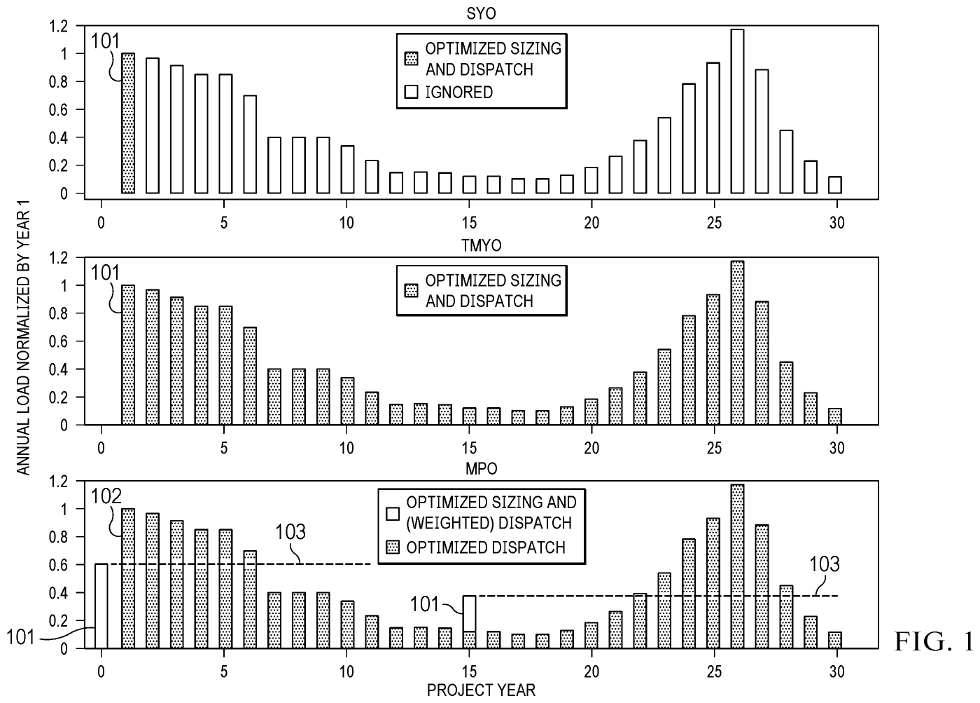

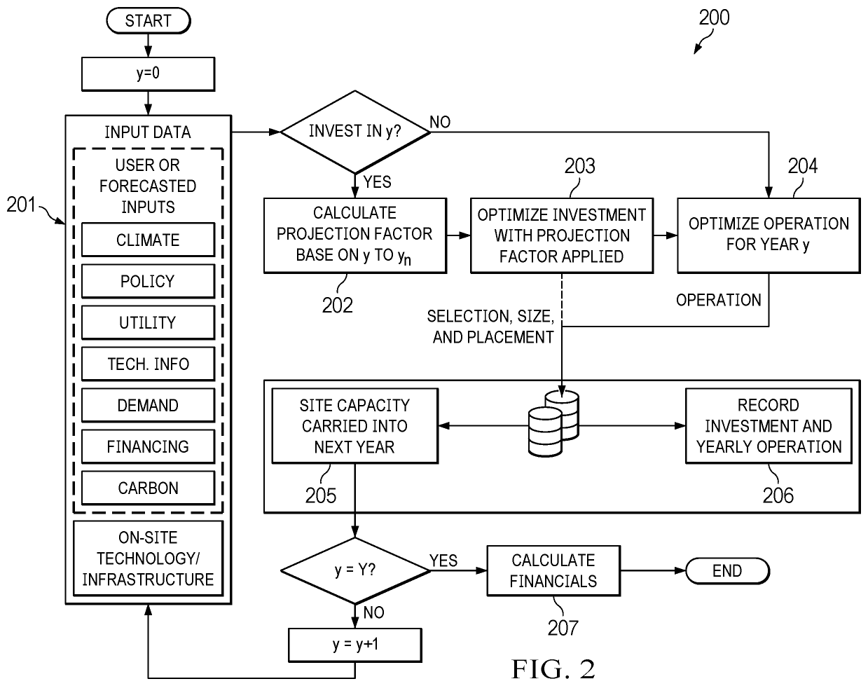

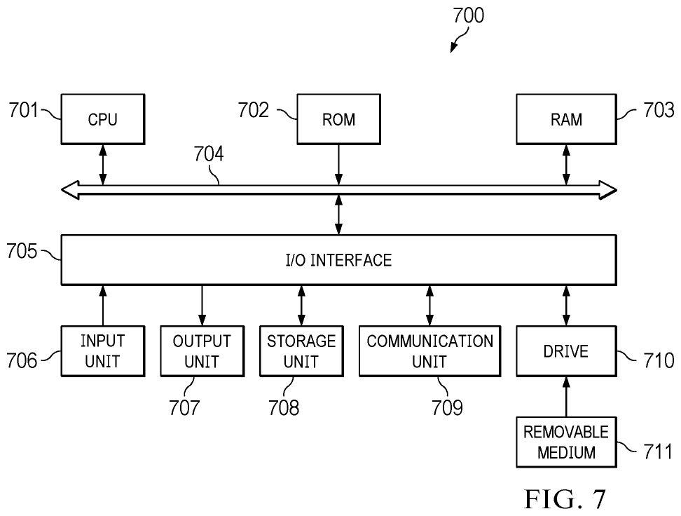

FIG. 1 is a conceptual example and FIG. 2 is a block diagram illustrating a fast multiyear projection based microgrid and DER planning method, according to an embodiment. The planning method estimates microgrid and DER planning parameters for a particular site, place, building, or geographic region under consideration by a stakeholder (hereinafter collectively referred to as a “facility”) for multiple years. The planning parameters include, but are not limited to, technology mix, costs, capital expenditure (CAPEX), operating expenses (OPEX), net present value (NPV), internal rate of return (IRR), return on investment (ROI), and environmental impact. The method can be implemented using a cloud-based computing platform (e.g., with computing apparatus shown in FIG. 7), where stakeholders access the platform through a network (e.g., the Internet) using a desktop computer or mobile device.

In an embodiment, the adaptive method used to solve the economic planning can include two or more linear or non-linear cascaded solvers, such as simulation, linear programming (LP) optimization, or modeling. The solver can be stochastic or deterministic in nature.

As used herein, a “power grid” is a network of power providers and consumers that are connected by transmission and distribution lines and operated by one or more control centers. As used herein a “microgrid” or “minigrid” is a group of interconnected loads and DER systems within defined electrical boundaries that act as a single controllable entity with respect to the power grid. A microgrid/minigrid can connect and disconnect from the power grid to enable it to operate in both grid-connected or island-mode. As used herein, “DER” systems are small-scale power generation or storage technologies (typically in the range of 1 kW to 10,000 kW) used to provide an alternative to, or an enhancement of, a traditional power grid. Microgrid can also include heat, cooling, and other forms of energy delivery. The discussed method can be applied to the power grid, microgrid, minigrid, or other forms of DERs. Collectively, power grid, microgrid, minigrid, or other forms of DERs are also referred to herein as “energy systems.”

### General Approach

The disclosed method assumes that a standard ‘typical year model as described above is being solved. The methods apply regardless of planning approach, but optimization will be used as an example hereafter. Referring to FIG. 1, the single year optimization has a projection factor applied to one or more inputs, which is a condensed version of future forecasts represented through a single factor. The solution produced by optimizing the single year with projection factors applied creates a ‘typical future year’ with sizing optimal for that scenario, and dispatch to match. To get accurate economics and dispatch using the real provided forecasts, the method is connected to an adaptive multiyear approach (as described above), which steps through and solves each year of the horizon sequentially to avoid exponential growth of a problem with years considered.

Investments can be made in each of these years using the projection factors based on the future forecasts (e.g., could be at the start of the project only or maybe every five years). For each investment year, two optimizations are computed. First an optimization is run with the projected data being used to get assets sizing, selection, and placement. Next the decisions from those solutions are used in a dispatch only optimization to get optimal operation on the real data and the corresponding economics. For years which are not considering investment, only a single dispatch solution needs to be generated which considers all previous investment.

This process flow is depicted in FIG. 1, as well as shows the TMYO and SYO for comparison. Note in FIG. 1, the bars 101 represent the optimization in which investment is being considered. While the bars 102 represent a dispatch only optimization. Note how in year 15 both sizing and dispatch runs are performed. The dashed lines 103 represent the ‘horizon’ off years being considered to create the projection factor for that optimization.

The steps described above are repeated in an iterative process with the updated current system. The time series generated in the first step is now representative of the next year through the time the horizon. The database which houses the data stored for each solution is accessed following the completion of the iterative process. The data is used to calculate lifetime values for the project such as IRR, NPV, and ROI, among others. The number of years to consider for the complete horizon is variable from one to infinity, limited only by computer run-time and storage.

### Calculation Methods for Projection Factors

In some embodiments, a projection factor is calculated for and applied to each timestep of the optimization for data which is time dependent. In a simpler form, a single projection factor can be applied across all time-steps. For non-timestep dependent inputs, a single projection factor is applied.

In an embodiment, the projection factors are calculated to represent the change in the input relative to the current state of the input. Hereafter, the time-series of forecasted data over the project horizon is referred to as the “future data” and the current state of the data as the “current data.” A few key methods to calculate the projection factors are given in the next few embodiments described below.

Simple mathematical operators between the changing data and the current state such as the maximum, average, or summation of the data can be applied. In TABLE I below examples of these mathematical operators are listed, assuming a single projection factor is applied to all timesteps is given. Note the maximum is especially needed for representing islanded microgrids, where representing the “worst year” provides a robust result large enough to meet the demand in every year.

Here, PrFₗ_{ₜ} is the projection factor calculated for an input I which changes within a year (e.g., over timesteps t) and across multiple years (e.g., over years y∈Y). The denominator always considers y=0, which is the initial data value.

TABLE I
Example Mathematical Operators

| Mathematical | | |
|---|---|---|
| operator | Applied at each timestep | Factor for all timesteps |
| Average ratio | ${PrF}_{{I}_{t}} = \frac{{\sum }_{y} ( {I}_{t , y} ) / Y}{{I}_{t , o}}$ | ${PrF}_{I} = {\sum }_{t} \frac{{\sum }_{y} ( {I}_{t , y} ) / Y}{{I}_{t , o}}$ |
| Maximum ratio | ${PrF}_{{I}_{t}} = {max}_{y} \frac{{I}_{t , y}}{{I}_{t , o}}$ | ${PrF}_{I} = {max}_{y} {\sum }_{t} \frac{{I}_{t , y}}{{I}_{t , o}}$ |
| Ratio of sums | ${PrF}_{{I}_{t}} = \frac{{\sum }_{y} ( {I}_{t , y} )}{{\sum }_{y} ( {I}_{t , o} )}$ | ${PrF}_{I} = {\sum }_{t} \frac{{\sum }_{y} ( {I}_{t , y} )}{{\sum }_{y} ( {I}_{t , o} )}$ |

In some embodiments, discounting is applied to the future values. The term “discounting” refers to applying a discount factor to future values, decreasing their impact on the solution. This is common practice is financial cashflow analysis but has not been applied to technical terms. This approach is given in the TABLE II. Here δ is the discount rate applied to discount the future values, and the projection factor becomes a function of the discount rate. Here, PrFₗ_{ₜ} is the projection factor calculated for an input I is an input which changes within a year (e.g., over timesteps t) and across multiple years (e.g., over years y∈Y). The denominator always considers y=0, which is the initial data value.

TABLE II
Example Discounting Method

| Method | Applied at Each Timestep | Factor for All Timesteps |
|---|---|---|
| Discounted Ratio | ${PrF}_{{I}_{y}} ( δ ) = \frac{( \frac{{\sum }_{t} {I}_{t , y}}{{( 1 + δ )}^{y - 1}} )}{( \frac{{\sum }_{t} {I}_{t , o}}{{( 1 + δ )}^{y - 1}} )}$ | ${PrF}_{I} ( δ ) = {\sum }_{t} \frac{( \frac{{\sum }_{t} {I}_{t , y}}{{( 1 + δ )}^{y - 1}} )}{( \frac{{\sum }_{t} {I}_{t , o}}{{( 1 + δ )}^{y - 1}} )}$ |

The choice of discount rate δ allows for the ‘tuning’ of the impact of the future forecasts. This is most noticeable by looking at the extreme values. This is given below in TABLE III in both equation and graphical form.

TABLE III
Example Discount Rate Extreme Values

| Limit of Highest | Limit of Lowest |
|---|---|
| Possible Discount Rate δ = ∞ | Possible Discount Rate δ = 0 |
| ${lim}_{δ \to ∞} PrF = \frac{{I}_{t , o}}{{I}_{t , o}}$ | ${lim}_{δ \to ∞} PrF = \frac{{\sum }_{y} ( {I}_{t , y} ) / Y}{{\sum }_{y} ( {I}_{t , o} )}$ |

FIG. 2. is a block diagram of MPO process 200, according to one or more embodiments. For years where investments are considered, projection factors are calculated to condense a number of years into a single factor, and a sizing optimization is run applying those factors.

In some embodiments, process 200 includes input data 201, which can be user or forecasted inputs (e.g., climate, policy, utility, technical information, demand, financing, carbon emissions, on-site technology/infrastructure). Based on input 201, a decision is made to invest in a user specified year y. If yes, projection factors based on a multiyear forecast (years y to yₙ) are calculated 202 and investment is optimized (e.g., by solving a first optimization problem on investment) with the projection factors applied 203, and the results (e.g., energy system asset selection, size, placement) are recorded in a storage device. Next, operation is optimized for the specified year y (204) and the results of the optimization (e.g., operation) are recorded in the storage device.

Based on the stored data, a record of investment and yearly operation can be generated 206 upon request. The site capacity is then carried into the next year 205 for the next iteration of process 200, where the specified year y is incremented by one (y=y+1) until a maximum number of years Y in the multiyear forecast is reached (e.g., 20-year forecast). If Y is reached, the iteration of process 200 terminates and reports (e.g., financial reports) are calculated 207 based on the results of process 200.

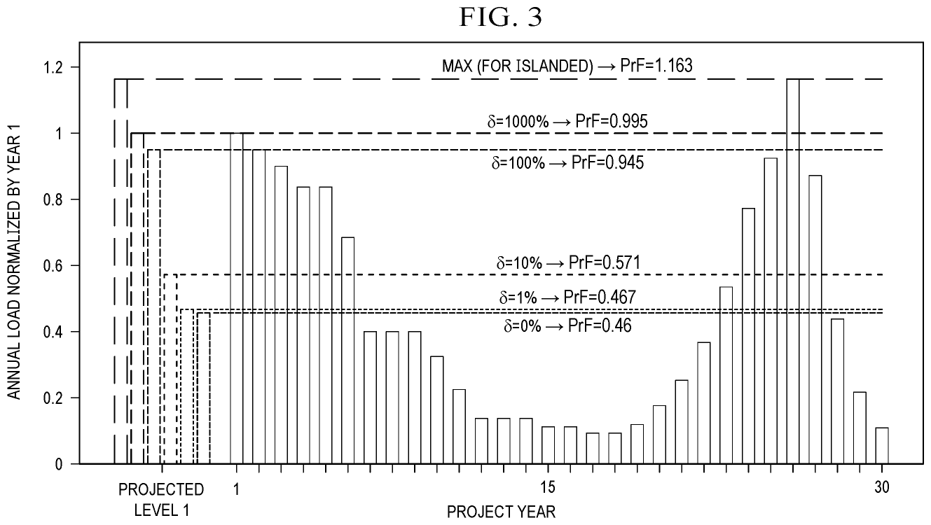

FIG. 3 shows the impact of tuning by selecting multiple values of δ. TABLE IV below is example calculation of the projection factors using the discounting approach with a discount rate of 2% and a constant increase of 5% for the variable each year of the project.

TABLE IV
Example Calculation of Projection Factors Using Discount Rate

| Project | Original Value | | Multiyear Value | | |
|---|---|---|---|---|---|
| Year | Value | Discounted | Value | Discounted | PrF |
| 1 | 1 | 1 | 1 | 1 | |
| 2 | 1 | 0.98 | 1.05 | 1.03 | |
| 3 | 1 | 0.96 | 1.10 | 1.06 | |
| 4 | 1 | 0.94 | 1.16 | 1.09 | |
| 5 | 1 | 0.92 | 1.22 | 1.12 | |
| 6 | 1 | 0.91 | 1.28 | 1.12 | |
| 7 | 1 | 0.89 | 1.34 | 1.19 | |
| 8 | 1 | 0.87 | 1.41 | 1.23 | |
| 9 | 1 | 0.85 | 1.48 | 1.26 | |
| 10 | 1 | 0.84 | 1.55 | 1.29 | |
| sum | | Σ = 9.16 | | Σ = 11.43 | 9.16/11.43 = 1.25 |

Other methods of calculating the projection factor could include data mining, clustering, or other advanced statistical approaches.

### Example Results Comparison

In terms of runtime, the MPO method cuts significant time off the TMYO method and has much lower variance in the calculation time (meaning it is faster and more predictable). Based on the results, the MPO only takes 134 seconds on average while TMYO takes 6.5 times longer on average at 841.6 minutes. Further the variance in runtime is a factor of 5.

TABLE V below examines several sensitives in future values. The computation statistics of the methods introduced above, from a set of sensitivity optimizations performed to stress test the approaches on a sample 20-year project. Note the similarities in computation effort of MPO sizing and SYO, and the different between MPO combination (sizing plus dispatch) and the TMYO (also solves sizing and dispatch).

TABLE V
Examples of Sensitivities in Future Values

| | | Mean (μ) | | |
|---|---|---|---|---|
| | | Total (20 years)[s] | Std. dev. [s] | Max [s] |
| SYO | | 24.2 | 2.2 | 27.4 |
| MPO | Sizing | 25.1 | 2.1 | 29.1 |
| | Dispatch | 110.8 | 14.1 | 126.4 |
| | Combination | 134.9 | 15.9 | 141.0 |

| | | | |
|---|---|---|---|
| TMYO | 841.6 | 73.4 | 1121.3 |

MPO produces solutions which are very close to the TMYO solution (current state of the art) and improve significantly over SYO (also current state of the art), regardless of the trend of the forecast (e.g., ascending prices, descending prices, prices which go up then down, and prices which go down then up, etc.). SYO over invests and loses money over the project, while MPO swiftly avoids over investing and losing money over the project due to its information about the future.

### User Specified Forecasts

In some embodiments, the list of input variables that can be used in the simulation or optimization, include but are not limited to: (i) solar irradiance; (ii) solar performance; (iii) wind speed; (iv) wind performance; (v) customer demand for a number of end uses such as electrical, cooling, refrigeration, thermal, hot water, steam, chilled water; (vi) utility tariffs including energy tariffs such as time of use, dynamic or real time rates, and tiered tariffs, demand charges, standby costs, backup power charges, and fuel charges such as natural gas, diesel, hydrogen; (vii) regulatory constraints such as carbon taxes, emissions limits, incentives; and (viii) technology costs such as capital expenses and operating costs.

In some embodiments, the user can specify the forecasted values manually for the lifetime of the project. The forecasts can be set completely or partially, where missing data is filled in by the AI forecasting technique. In some embodiments, users can enter forecasted values, by either specifying exact values to use, or percentage changes that can apply to previous data. When using exact values, users can either enter a time-series or average values, which the AI will turn into the time series. Further, the user could enter these values or draw curves to represent the values. Similarly, percentages can be given as a time series, a table, or as a curve. The numbers can apply to either the first-year data, or data from a previous year.

### Automated Forecasts

In some embodiments, automated forecasts are generated through AI, machine learning, statistical, or deterministic approaches. The forecasts can use sources, such as historical data, published opinions, legal proceedings, or other forecasts in their predictions. The forecasts would provide all input data required to run the model that is not provided by the user, including, but not limited to, the input data shown in FIG. 1. The automated forecasts determine where users did not identify data points. These data points can be inferred by the model (e.g., machine learning model).

### Numerical Example—Adaptive Method

A realistic example of the adaptive method using a 1-year horizon is given below using a linear programming optimization approach. In some embodiments, a simple objective function representative of economic planning is given by:

min c:c_{tariff}+c_{fuel}+c_{DER}+c_{carbon}−rₛₐₗₑₛ,

subject to the energy balance equation,

Energy Balance: L_{i,e}+Σₜ₌₁^{T}(S_{i,t,e}+K_{i,t,e})=Σₜ₌₁^{T}P_{i,t,e}+U_{i,e}.

In the Energy Balance equation above, e is a specific end use type, such as electricity or refrigeration, index i is representative of any time instance over the horizon, and index t represents the contributions of a single technology.

The Energy Balance equation above states that the summation of the energy demand L, the energy consumed by any technology K (e.g., battery or absorption chillers) and the energy sold from the energy system S, must be balanced with the sum of the energy produced by the energy system P, and the energy purchased for the energy system U. The objective function in this case is to minimize the total operation cost c, over the entire horizon (e.g., 1 year), which is a function of the individual costs of energy tariffs (c_{tariff}), fuel costs (c_{fuel}), costs to operate energy producers (c_{DER}), costs of carbon emissions (c_{carbon}), and the revenue from sales (rₛₐₗₑₛ). Other costs or objective functions can also be used.

In some embodiments, the cost of tariff term (c_{tariff}) is given by:

c_{tariff}=Futil+Σ_{i,e}(Vutl_{i,e}*U_{i,e})Σ_{i,e}(Dutil_{i,e}*max (U_{i,e})).

Here the tariff cost is equal to a fixed charge “Futil” plus a volumetric energy charge “Vutil” multiplied with the energy consumption “U” plus a demand charge “Dutil” multiplied with maximum of energy consumption for any time instance. The optimization problem solver will try to minimize this term, simultaneous with all other objectives, by purchasing DER or manipulating load, therefore minimizing the costs the customer must pay for energy.

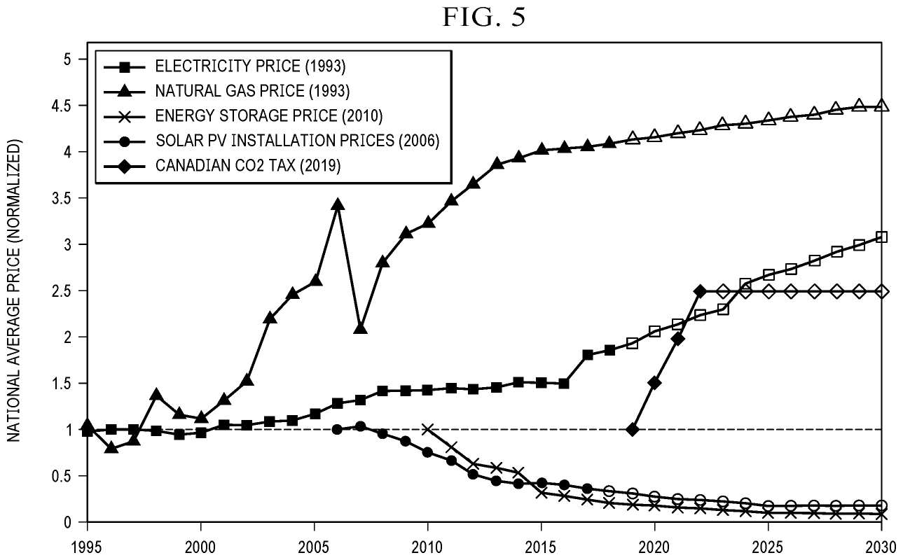

As described in reference to FIG. 3 and the General Approach, the above objective function is solved twice using forecasted input data. In this example, representative forecasts for several inputs are used as shown in FIG. 5. The load forecast is not shown but is assumed to increase at a fixed rate of 2% per year. All other inputs are assumed to not increase for this example. For this example, tracking carbon costs show that increases by 50% every year until 2021, where it remains flat. For this example, the optimization starts at year 2019 and only considers prices for that year. Therefore, in the first iteration, the carbon is 50% higher than it was in 2019. For this example, the energy system is assumed not to have any currently existing on-site generators.

Following the input of the initial data, the optimization step begins. In this step, the linear program is solved twice. The first solution represents the “as-is” condition of the energy system, by restricting any new investment. This solution determines the operating conditions (e.g., costs, emissions) of the energy system in its present state. These operating conditions are used as additional input into the second solution of the linear program, which removes the restriction on investment to purchase generation resources to improve the operating conditions of the energy system.

In some embodiments, the operating conditions from both solutions, along with the investments made are sent to an external database where all relevant data is stored for reporting purposes. The new investments made also represent an input into the model during the next iteration, where the invested generators are now considered existing assets. For this example, the new investments made were 150 kW of solar photovoltaic generators, and 250 kW natural gas generator. Therefore, in the second iteration of the method (year 2), the system is assumed to have those generation sources when entering the “as-is” phase of the solution method.

In addition to the existing on-site generation changing, the rest of the input data is updated based on the forecasted data. For this example, that means all data are updated to reflect 2020 prices, where here the price of carbon has increased by 100% since 2018. The two-phase solution is repeated, where operating conditions and new investments are determined, sent to the databases, and used to update the existing system. This loop is repeated for as long as the user specifies, which will determine the operation and investment summary for that period of years.

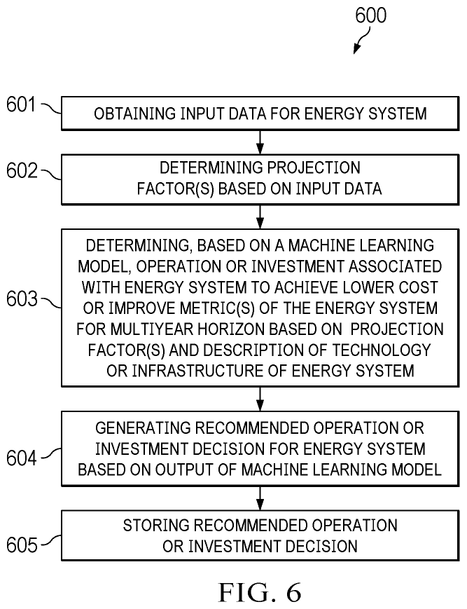

FIG. 6 is a flow diagram of an MPO process 600, according to one or more embodiments. Process 600 can be implemented, for example, by the computing apparatus described in reference to FIG. 7.

In an embodiment, process 600 is an iterative process that includes: obtaining input data for an energy system (601); determining one or more projection factors based on the input data (602), where the one or more projection factors condense forecasts for the energy system, over a multiyear horizon, into a single number to represent future conditions associated with the energy system, and where the one or more projection factors tune the impact of the future forecasts using a discount rate; determining, based on a machine learning model, an operation or investment associated with the energy system to achieve lower cost or improve one or more metrics of the energy system for the multiyear horizon based at least in part on the one or more projection factors and a description of technology or infrastructure of the energy system (603); generating a recommended operation or investment decision for the energy system based at least in part on output of the machine learning model (604); and storing the recommended operation or investment decision (605). Each of these steps were described more fully above.

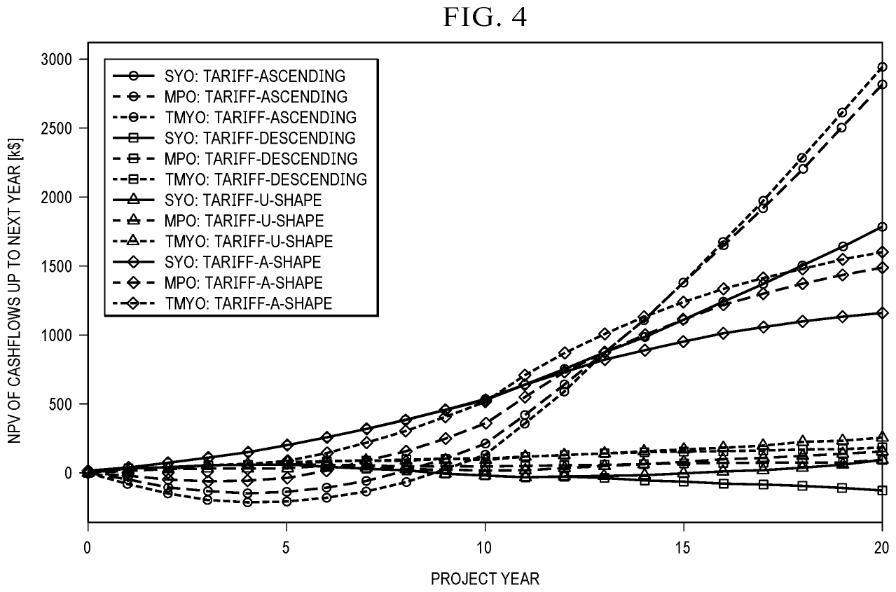

FIG. 7 shows a block diagram of an example computing apparatus 700 suitable for implementing example embodiments of the present disclosure. Computing apparatus 700 includes but is not limited to servers and client devices, as previously described in reference to FIGS. 1-6. In some embodiments, one or more computing apparatus 700 (e.g., servers) are part of a cloud-based computing platform.

As shown, the apparatus 700 includes central processing unit (CPU) 701 which is capable of performing various processes in accordance with a program stored in, for example, read only memory (ROM) 702 or a program loaded from, for example, storage unit 708 to random access memory (RAM) 703. In RAM 703, the data required when CPU 701 performs the various processes is also stored, as required. CPU 701, ROM 702, RAM 703 are connected to one another via bus 704. Input/output (I/O) interface 705 is also connected to bus 704.

The following components are connected to I/O interface 705: input unit 706, that may include a keyboard, a mouse, or the like; output unit 707 that may include a display such as a liquid crystal display (LCD) and one or more speakers; storage unit 708 including a hard disk, or another suitable storage device; and communication unit 709 including a network interface card such as a network card (e.g., wired or wireless).

In some implementations, input unit 706 includes one or more microphones in different positions (depending on the host device) enabling capture of audio signals in various formats (e.g., mono, stereo, spatial, immersive, and other suitable formats).

In some implementations, output unit 707 include systems with various number of speakers. Output unit 707 (depending on the capabilities of the host device) can render audio signals in various formats (e.g., mono, stereo, immersive, binaural, and other suitable formats).

In some embodiments, communication unit 709 is configured to communicate with other devices (e.g., via a network). Drive 710 is also connected to I/O interface 705, as required. Removable medium 711, such as a magnetic disk, an optical disk, a magneto-optical disk, a flash drive, or another suitable removable medium is mounted on drive 710, so that a computer program read therefrom is installed into storage unit 708, as required. A person skilled in the art would understand that although computing apparatus 700 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine-readable medium, the computer program including program code for performing methods. In such embodiments, the computer program may be downloaded and mounted from the network via the communication unit 709, and/or installed from the removable medium 711, as shown in FIG. 7.

Generally, various example embodiments of the present disclosure may be implemented in hardware or special purpose circuits (e.g., control circuitry), software, logic, or any combination thereof. For example, the units discussed above can be executed by control circuitry (e.g., CPU 701 in combination with other components of FIG. 7), thus, the control circuitry may be performing the actions described in this disclosure. Some aspects may be implemented in hardware, while other aspects may be implemented in firmware or software which may be executed by a controller, microprocessor, or other computing device (e.g., control circuitry).

While various aspects of the example embodiments of the present disclosure are illustrated and described as block diagrams, flowcharts, or using some other pictorial representation, it will be appreciated that the blocks, apparatus, systems, techniques, or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine-readable medium, the computer program containing program codes configured to carry out the methods as described above.

In the context of the disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may be non-transitory and may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general-purpose computer, special purpose computer, or other programmable data processing apparatus that has control circuitry, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

While this document contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination. Logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
obtaining, with at least one processor, input data for an energy system;
determining, with the at least one processor, one or more projection factors based on the input data, the one or more projection factors to condense forecasts for the energy system, over a multiyear horizon, into a single number to represent future conditions associated with the energy system, where the one or more projection factors tune the impact of the future forecasts using a discount rate;
determining, with the at least one processor and based on a machine learning model, an operation or investment associated with the energy system to achieve lower cost or improve one or more metrics of the energy system for the multiyear horizon based at least in part on the one or more projection factors and a description of technology or infrastructure of the energy system;
generating, with the at least one processor, a recommended operation or investment decision for the energy system based at least in part on output of the machine learning model; and
storing, with the at least one processor, the recommended operation or investment decision.

2. The method of claim 1, wherein the input data is a state of the energy system representing technology assets on-site or in the energy system, system constraints, and a forecast of inputs over the multiyear horizon.

3. The method of claim 2, wherein the forecast of inputs is generated using machine learning.

4. The method of claim 1, wherein the one or more projection factors are determined for and applied to each timestep of the multiyear forecasts for input data which is time dependent.

5. The method of claim 1, wherein a single projection factor is determined for and applied across all time-steps of the multiyear forecasts.

6. The method of claim 1, wherein new investments resulting from a first iteration of the method are added to the input data in a following iteration of the method.

7. The method of claim 1, further comprising:
determining, using an adaptive multiyear approach, accurate dispatch for each year of the multiyear horizon based on the investment, or an incremental dispatch by combining the adaptive multiyear approach with the machine learning model and the one or more projection factors.

8. A system comprising:
at least one processor;
memory storing instructions that when executed by the at least one processor, cause the at least one processor to perform operations comprising:
obtaining input data for an energy system;
determining one or more projection factors based on the input data, the one or more projection factors to condense forecasts for the energy system, over a multiyear horizon, into a single number to represent future conditions associated with the energy system, where the one or more projection factors tune the impact of the future forecasts using a discount rate;
determining, based on a machine learning model, an operation or investment associated with the energy system to achieve lower cost or improve one or more metrics of the energy system for the multiyear horizon based at least in part on the one or more projection factors and a description of technology or infrastructure of the energy system;
generating a recommended operation or investment decision for the energy system based at least in part on output of the machine learning model; and
storing the recommended operation or investment decision.

9. The system of claim 8, wherein the input data is a state of the energy system representing technology assets on-site or in the energy system, system constraints, and a forecast of inputs over the multiyear horizon.

10. The system of claim 9, wherein the forecast of inputs is generated using machine learning.

11. The system of claim 8, wherein the one or more projection factors are determined for and applied to each timestep of the multiyear forecasts for input data which is time dependent.

12. The system of claim 8, wherein a single projection factor is determined for and applied across all time-steps of the multiyear forecasts.

13. The system of claim 8, wherein new investments resulting from a first iteration of the method are added to the input data in a following iteration of the method.

14. The system of claim 8, further comprising:
determining, using an adaptive multiyear approach, accurate dispatch for each year of the multiyear horizon based on the investment, or an incremental dispatch by combining the adaptive multiyear approach with the machine learning model and the one or more projection factors.
